(19) United States
(12) Patent Application Publication
(10) Pub. No.: US 2025/0136308 A1
(43) Pub. Date: May 1, 2025

(54) DRONE SYSTEM

(71) Applicant: Sphere Drones Holdings Pty Ltd, Sydney (AU)

(72) Inventor: Paris COCKINOS, Sydney (AU)

(21) Appl. No.: 18/926,714

(22) Filed: Oct. 25, 2024

(30) Foreign Application Priority Data
Oct. 27, 2023 (AU) 2023903452

(51) Int. Cl. B64U 80/86; H02S 20/30; H02S 30/20

(52) U.S. Cl. CPC B64U 80/86; H02S 20/30; H02S 30/20

(57) ABSTRACT

There is disclosed herein a drone system including: a trailer including a chassis and a draw bar extending from the chassis, the chassis being supported on a surface by one or more wheels and one or more support members; a plurality of cabins mounted to the chassis, with each cabin having an upper surface; at least one solar panel assembly mounted to an upper surface of one of the cabins; and a drone landing dock provided on an upper surface of another one of the cabins.

### CROSS-REFERENCE TO RELATED APPLICATION

This application claims priority to Australian Provisional Patent Application No. 2023903452 filed Oct. 27, 2023, the disclosure of which is incorporated herein by reference in its entirety.

### FIELD

The present invention relates to a drone system. In particular, the present invention relates to a vehicle-mounted drone deployment system.

The invention has been developed primarily for use in applications involving mobile drone technology and will be described hereinafter with reference to these applications. However, it will be appreciated that the invention is not limited to this particular field of use, and may also be employed in other applications.

### BACKGROUND

Known drone systems typically rely on an operation structure of one pilot and one drone or one pilot and multiple drones (swarms). The use cases and applications of such systems are highly limited as they are only capable of supporting single technologies. In sectors such as security, agriculture, survey, and mining, the operation of such known systems can be labour-intensive, costly, and inefficient from a scalability perspective. There are also significant barriers to accessibility and deployment of such systems in remote areas for non-tech experts and businesses. Such barriers to accessibility may include aviation approval, communication to airspace vehicles, understanding of the location of airspace vehicles, physical installation into concrete or other substructures, internet connectivity, consistent power, and technical know-how to deployment.

### SUMMARY

It is an object of the present invention to substantially overcome, or at least ameliorate, one or more of the disadvantages of existing arrangements, or at least provide a useful alternative to existing arrangements.

There is disclosed herein a drone system including:
a trailer including a chassis and a draw bar extending from the chassis, the chassis being supported on a surface by one or more wheels and one or more support members;
a plurality of cabins mounted to the chassis, with each cabin having an upper surface;
at least one solar panel assembly mounted to an upper surface of one of the cabins; and
a drone landing dock provided on an upper surface of another one of the cabins.

The drone system may further include an air conditioning system housed in one of the cabins, wherein the air conditioning system is operable to manage the cooling and/or pressure of the cabins.

The one or more support members may be height-adjustable to allow for levelling of the drone system on uneven terrain.

The plurality of cabins may include:
a central cabin flanked by a first cabin and a second cabin,
wherein the drone landing dock is provided on an upper surface of the central cabin, and wherein the at least one solar panel assembly is provided on an upper surface of the first or second cabin.

The drone system may include two of the solar panel assemblies, with the first of the two solar panel assemblies being mounted on an upper surface of the first cabin, and the second of the two solar panel assemblies being mounted on an upper surface of the second cabin.

Each solar panel assembly may include a plurality of solar panels, wherein the solar panel assembly is moveable between a retracted configuration whereby the solar panels are in a stowed arrangement and an expanded configuration whereby the solar panels are in an outwardly extended arrangement.

Each solar panel assembly may include three solar panels, whereby in the retracted configuration, the three solar panels are stacked in relation to each other, and in the expanded configuration, two of the solar panels extend outwardly from the third, central solar panel.

Each solar panel assembly may be operatively associated with a charger, with the charger being located in any one of the cabins.

Each solar panel assembly may be operatively associated with a solar panel isolator located in one of the cabins.

The drone system may include a plurality of batteries located in any one or more of the cabins, wherein power from the solar panel assembly is stored across the plurality of batteries.

The batteries may be operatively associated with a battery isolator located in one or more of the cabins.

The batteries may be housed in one or more modular frame structures located in one of the cabins.

The modular frame structures may be repositionable to allow for weight distribution of the batteries across the trailer.

The central cabin, first cabin, and second cabin may be integrally formed to have a common internal cavity. Alternatively, the central cabin, first cabin, and second cabin may be separately formed.

The cabins may each include a door providing access to the internal cavity, wherein the door includes waterproof seals having an IP67 Rating.

The cabins may include at least one port for mains supply, a generator, or any alternative power source.

The drone system may further include a drone assembly operatively associated with the mounting assembly.

The drone system may further include a watchtower assembly having:
a mast disposed over the draw bar of the trailer, with the mast being moveable between a retracted configuration and an extended configuration;
a bracket assembly adapted for mounting the mast to the draw bar; and
one or more IoT devices mounted to the mast and configured to provide real-time operational data associated with the system, with the one or more IoT devices being operatively associated with power and data components located within the cabins.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 is a schematic isometric view of a drone system according to one embodiment;

FIG. 2 is a schematic isometric view of a modular frame structure of a drone system according to one embodiment;

FIG. 3 is a schematic isometric view of a modular frame structure of a drone system according to another embodiment;

FIG. 4 is a schematic isometric view of a mounting assembly of a drone system according to one embodiment;

FIG. 5 is a schematic isometric view of a mounting assembly of a drone system according to another embodiment; and

FIG. 6 is a schematic isometric view of a drone system according to another embodiment.

### DETAILED DESCRIPTION

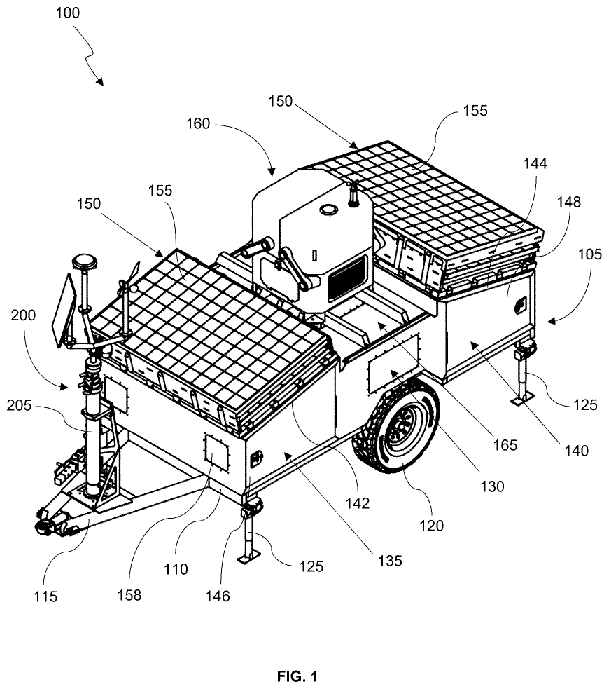

In FIG. 1 of the accompanying drawings, there is schematically depicted an embodiment of a drone system or a drone deployment system 100 that is adaptable for use with multiple technological applications. The drone system 100, at its core, includes a vehicle or transport in the form of a custom/bespoke trailer 105 as shown in the depicted embodiment. It will be appreciated that the build of the trailer 105 is not necessarily limited to the configuration shown in the drawings and described herein, and may be further customised depending on the specific design and use requirements of the system 100.

The trailer 105 is designed to primarily operate off-grid in remote areas such as mining sites. It will be appreciated that the application of the system 100 may additionally or alternatively extend to use cases such as, but not limited to, asset inspection (for compliance and preventative maintenance), construction and infrastructure, security and surveillance (defence), agriculture, transport, logistics, and entertainment. It is envisaged that global application(s) may be possible with minor compliance changes by providing a managed service, as will be described in further detail below. It will also be appreciated that the trailer 105 is designed to be compliant with trailer base certifications with the relevant regulatory bodies and other regulatory approval for operation.

In the depicted embodiment, the trailer 105 includes a frame or chassis 110 and a draw bar 115 extending from the chassis 110. The draw bar 115 may include conventional couplings that are adapted for connection to a vehicle (not shown). The chassis 110 may be supported on a surface (not shown) by one or more wheels 120 and one or more leg or support members 125, depending on the design requirements of the system 100. In one arrangement, the chassis 110 is supported by two wheels 120 disposed centrally on a single axle and four support members 125 disposed at the corners thereof. It is envisaged that the support members 125 may be height-adjustable to allow for levelling of the trailer 105 and associated components (such as a landing platform/dock for a drone, as will be described in further detail below) on uneven terrain. The height-adjustable arrangement of the support members 125 may at least allow for weight to be taken off the wheels 120. This arrangement may also allow the trailer 105 to be further secured/stabilised to prevent any roll in the event of the trailer brake failure or accidental knocking of the brake lever, for example. It will thus be appreciated that the trailer 105 is designed to take into consideration occupational health and safety (OH&S) requirements, along with ‘mobile’/‘transportable’ plant compliant considerations for commercial applications, for example.

In the depicted embodiment, the system 100 further includes a central compartment 130 flanked by a first compartment or cabin 135 and a second compartment or cabin 140, each being mounted to the trailer 105. In a preferred arrangement, the compartments 130, 135, and 140 are mounted to the chassis 110. In other embodiments (not shown), one or more of the cabins or compartments 130, 135, and 140 may be rearranged or removed, depending on the design requirements of the system 100. The cabins or compartments 130, 135, and 140 may be integrally formed to have a common cavity, or may alternatively be separately formed for assembly. Each cabin or compartment 130, 135, and 140 may be constructed from a suitable material such as 3 mm 5005 grade aluminium, welded to ISO9001 standards. It will be understood that other materials may be utilised, depending on the design requirements of the system 100.

In a preferred arrangement, the body of the first and second cabins or compartments 135 and 140 includes canopies or upper surfaces 142 and 144, respectively, and doors 146 and 148 providing access to the respective compartments 135 and 140. The upper surfaces 142 and 144 are preferably inclined. The doors 146 and 148 may each be shaped to correspond to the shape of the respective first and second cabins or compartments 135 and 140, such that the doors 146 and 148 may structurally reinforce the inclined upper surfaces 142 and 144. It will be appreciated that this structural reinforcement may at least allow for significant weight-load (up to 350 kg in preferred arrangements) to be supported overhead. In a preferred arrangement, the doors 146 and 148 (along with any other doors of the cabins or compartments 130, 135, and 140) may be provided with waterproof seals that have an IP67 Rating, for example. Further, the doors 146 and 148 may include ports for respective additional devices, such as, but not limited to, electronic central locking mechanisms and RGB lights to support setup and pre/post-light routines.

The system 100 may include a solar panel array/assembly 150 mounted to one or both of the upper surfaces 142 and 144. In the depicted embodiment, each solar panel assembly 150 includes three solar panels 155, although it will be appreciated that in other embodiments (not shown), each solar panel assembly 150 may include any number of solar panels 155, depending on the design requirements of the system 100.

The solar panel assembly 150 may be moveable between a retracted configuration as shown in the drawings, whereby the solar panels 155 are in a stacked or stowed arrangement, and an expanded configuration whereby at least one (and preferably two) of the solar panels 155 are unstacked or extended outwardly in a wing-style arrangement. The expanded configuration of the solar panel assembly 150 may at least allow for increased UV exposure to all the panels 155 so as to maximise power generation. It is envisaged that power generation may further be maximised by providing one charger to manage the solar panel assembly 150 mounted to the upper surface 142 and another charger to manage the solar panel assembly 150 mounted to the upper surface 144. One or both of the chargers may be adapted to inform and deliver an optimised power generation feed. The chargers may be located in any one of the cabins or compartments, preferably the second (power) cabin or compartment 140, as will be described further below.

Each solar panel assembly 150 may be provided with built-in cable management to support the expanded configuration. The cable management may at least allow for the operation of each solar panel assembly 150 in parallel.

Power from the solar panels 155 may be stored across a plurality of batteries (not shown) located within one or more of the compartments or cabins 130, 135, and 140. The number of batteries provided may vary depending on the use and design requirements of the system 100. The batteries are operatively associated with and adapted to power the various components of the system 100. It will be appreciated that the batteries and storage thereof are designed with the specifications of particular weather conditions in mind and in a preferred arrangement, the batteries and storage thereof are designed to suit Australian weather conditions in a solar environment. As will be described in further detail below, other considerations include the power draw of items/components of the system 100, such as the components that are housed within the compartments 135 and 140.

It is understood that the payload of the trailer 105 is not a constant load as the drone dock, for example, may change. Accordingly, it will be appreciated that the transporting and shifting of the overall balance of the trailer 105 may be achieved by the placement of the batteries along the length of the trailer 105. In a preferred arrangement, the batteries may be housed in one or more modular frame structures located inside any one or more of the compartments or cabins 130, 135, and 140, whereby the modular frame structures may be repositionable therein for weight distribution. In some arrangements, the compartments or cabins 130, 135, and 140 and/or the modular frame structures may include additional bracing such as dampening to support the mobile nature of the trailer 105.

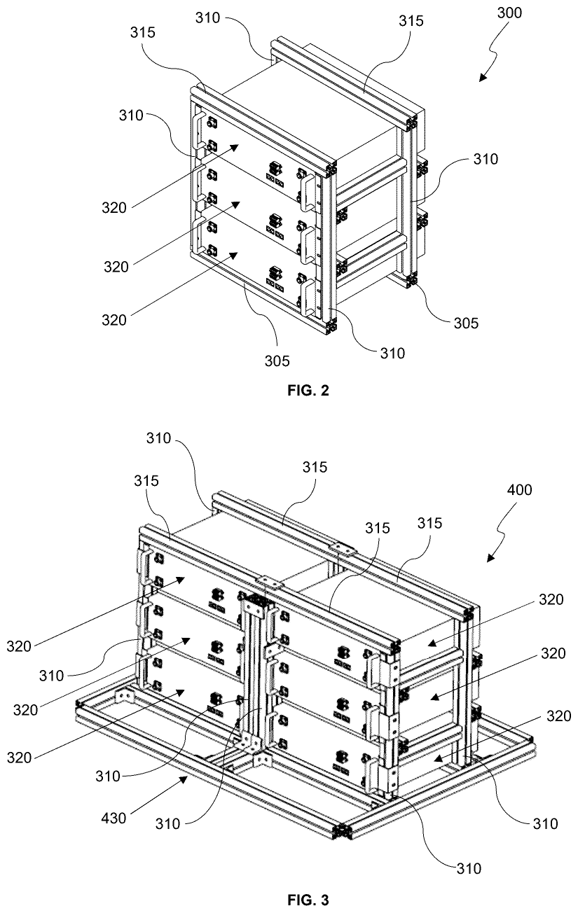

FIGS. 2 and 3 show exemplary embodiments of the modular frame structure, whereby the embodiment of FIG. 2 depicts a modular frame structure 300 that accommodates three batteries, whilst the embodiment of FIG. 3 depicts a modular frame structure 400 that accommodates a two by three battery arrangement.

In the embodiment of FIG. 2, the modular frame structure 300 includes a pair of lower (base) frame members 305, two pairs of upwardly-extending side frame members 310, and a pair of upper frame members 315. The modular frame structure 300 may further include transverse frame members 320 extending between the upwardly-extending side frame members 310. It is understood that the frame members 300, 305, 310, and 315 may be mounted to one another by any suitable mechanical means. In one arrangement, the modular frame structure 300 may have an overall height of between approximately 560 and 565 mm, an overall width of between approximately 520 to 525 mm, and an overall depth of between approximately 385 and 400 mm. In one preferred arrangement, the modular frame structure 300 may have an overall height of 563 mm, an overall width of 523 mm, and an overall depth of approximately 390 mm. Each of the frame members may have a width and depth of approximately 40 mm. As shown in the depicted embodiment, the modular frame structure 300 may house/accommodate up to three batteries 320. In one arrangement, each battery 320 may have a height of approximately 133 mm.

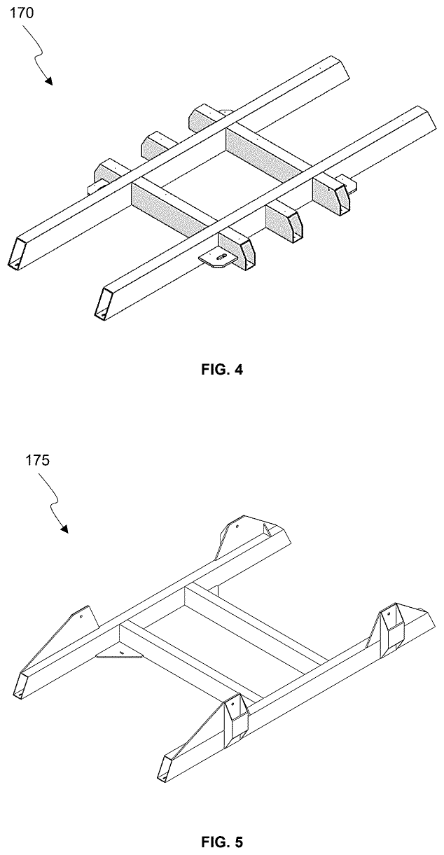

In the embodiment of FIG. 4, the modular frame structure 400 is understood to include two of the modular frame structures 300 in a side-by-side configuration. Accordingly, it will be appreciated that the modular frame structure 400 functions in a similar manner to the modular frame structure 300 described above, with like reference numerals being used to describe like features. In this embodiment, the modular frame structure 400 further includes a base assembly 430 to facilitate the repositioning/movement of the modular frame structure 400 within the compartments or cabins 130, 135, and 140. The modular frame structure 400 may be slidably mounted to the base assembly 430.

In the depicted embodiment, the first compartment 135 may accommodate a data rack or other operational components for a sub-assembly of the system 100, which will be described in further detail below. The second compartment 140 may accommodate the power components of the system 100. In a preferred arrangement, the components may form an integrated power system including, but not limited to, solar panel isolators, battery isolators, solar inverters, battery charges, and an AC power switchboard to house and distribute power (for generation, storage, and supply). As mentioned above, the second compartment 140 may also house the chargers for the solar panel assemblies. It will be appreciated that each of the above components may be connected via IoT devices to proprietary software for real-time data transfer and remote drone operation, as will be described in further detail below.

The first or second compartments 135, 140 may also provide access to the batteries and/or allow for extra storage of accessories, parts, tools, and spare wheels. In some arrangements, the first or second compartments 135, 140 include an inlet/outlet port 158 for mains supply in the event of battery fail over or where the batteries may require fast-charging. The inlet/outlet port 158 may also enable a generator or alternative power source to be used. Mobile generators, for example, are favoured on mine sites. As mentioned above, the first or second compartments 135, 140 may also house isolators for the batteries and the solar panel assembly 150. In a preferred arrangement, each solar panel assembly 150 is operatively associated with its own solar panel isolator, and the batteries are associated with a battery isolator.

The system 100 may further include an air conditioning (AC) system and in a preferred arrangement, the first or second compartments 135, 140 may house an air conditioning (AC) bay, with AC ducts that pipe into each compartment. The temperature and other operating conditions of the AC system may be managed by a computing device that is housed within one of the compartments. It is understood that the computing device includes a memory storing a software application and a processor for executing the software application, and the cooling and/or pressure of the compartments may be controlled in response to user input in the software application and/or in response to one or more sensors and/or interfaces of the system 100. In one example, the compartments may also be provided with temperature ‘ambient’ sensors to facilitate the control of the cooling of the compartments. It will be appreciated that control of the cooling and/or pressure of the compartments may at least allow for the devices or components within the compartments to stay within the required protocols of a server rack. This is particularly important in rural and remote locations whereby the temperature may reach in excess of 40 degrees Celsius during summer. Control of the pressure of the compartments may also allow for pressure to be kept on the doors to support the IP67 Rating.

The system 100 may further include a drone assembly 160 mounted to the central compartment 130. In the depicted embodiment, the drone assembly 160 is fitted to the top/upper surface of the central compartment 130 via an interchangeable module or mounting assembly to allow for different drone models, accessories, and/or alternative payloads to be utilised. This arrangement provides the landing platform/dock (also known as a payload area) 165 for the drone of the drone assembly 160 or for alternative payloads. Such alternative payloads may include a high gain low earth orbit (LEO) satellite antenna which may act as a node for other devices. In one preferred form, the payload area 165 may have a surface area of approximately 1706 mm by 963 mm. It is envisaged that the mounting assembly of the system 100 is designed to be compatible/operatively associated with any Drone in a Box (DiaB) system.

FIGS. 4 and 5 show exemplary embodiments of the mounting assembly, whereby the embodiment of FIG. 4 depicts a first embodiment of a mounting assembly 170, whilst the embodiment of FIG. 5 depicts a second embodiment of a mounting assembly 175. It will be understood that each of the mounting assemblies 170, 175 in the depicted embodiments are designed to be compatible with an associated DiaB system such as a DJI Dock Drone Station (mounting assembly 170) or a Hextronics Atlas Drone Station (mounting assembly 175).

The drone assembly 160 may be powered by the plurality of batteries, and located below the payload area 165 are a number of ports for plug and play application. In a preferred arrangement, the ports may include two data ports and two AC power ports, along with two ports for the solar panel assemblies 150. Notably, the arrangement of the trailer 105 differs from existing applications in that a concrete footing/padding is not required to provide levelling for the drone assembly 160 and/or associated components of the system 100.

In some embodiments, the system 100 may be provided with a watchtower assembly 200 for remote application and operation of the system 100. It will be appreciated that the watchtower assembly 200 may at least provide appropriate clearance for various communication/monitoring devices of the system 100 and facilitate situational awareness for the system 100. In the depicted embodiment, the watchtower assembly 200 includes a mast 205 installed over draw bar 115 of the trailer 105. The mast 205 may be movable between a retracted or stowed configuration and an extended configuration. The mast 205 may be a pump action mast and may be connected/attached to the draw bar 115 by way of a bracket or mounting assembly 210.

The bracket assembly 210 may include a main bracket having a base portion mountable to the draw bar 115 and one or more arm portions that extend upwardly from the base portion. The base portion may be mounted to the draw bar at any number of mounting points (ideally between four to eight), depending on the requirements of the mast 205. In a preferred form, the base portion is mounted to the draw bar with six bolting points. The one or more arm portions may terminate at a support portion that is adapted to hold the mast 205 at a distance from the base portion. The bracket assembly 210 may include one or more brace members extending between the base portion and the arm portion to provide additional structural rigidity. Due to the off-road functionality of the system 100, it will be appreciated that the bracket assembly 210 may provide the watchtower assembly 200 with sufficient rigidity in order to withstand significant shocks and sways when in a stowed position. In one arrangement, the bracket assembly 210 may include topology optimisation to reduce weight and to maximise strength. The bracket assembly 210 may also include a stud pattern to enable optimal mounting of the mast 205 to the trailer 105. The bracket assembly 210 may also include one or more further brackets distributed above the main bracket along the length of the mast 205 to provide additional support for the mast 205 during operation and whilst in transit.

In a preferred arrangement, the watchtower assembly 200 has a minimum extended height of 2.5 m. The watchtower assembly 200 may have a maximum extended height (measured from ground level) of 3.8 m. The extended arrangement of the watchtower assembly 200 may at least allow for clearance over obstacles for situational awareness compliance.

The watchtower assembly 200 may be operatively associated with the drone assembly 160 and a data rack (not shown) housed within the first compartment 135. As mentioned above, the watchtower assembly 200 may host any number of IoT devices configured to feed real-time data to software applications which may instruct and support the orchestration of remote drone operation. The IoT devices may be interchangeable as required. It is envisaged that the IoT devices may include (but are not limited to) one or more of the following:
a) Air band radio and antenna: a compliance pre-requisite (CASA) for remote communication to air traffic around the area of deployment of portable platform.
b) ADS-B antenna to receive transmission from aircraft within a vicinity of approximately 500 km of the trailer: another compliance pre-requisite (CASA) and only available as a single unit manually operated otherwise.
c) Dual-purpose 360 degree and PTZ (pan-tilt zoom) situational awareness camera to provide visuals on the location of the drone from a safety and compliance perspective.
d) Weather station to determine wind direction, wind speed, precipitation, lightning, pressure, and humidity to guide safe drone operations.
e) GNSS (GPS) base station to aid in precision flight, mission and return-to-base landing. Also used in post-processing functions of data capture to create centimetre accuracy in surveying applications.
f) Elsight Modem and antenna (connectivity #1) to host data sim cards from various providers delivering encrypted connectivity to cloud services and fail over connectivity to STARLINK.
g) STARLINK (connectivity #2) for high-speed internet.

The system 100 may be provided with built-in internet connectivity options (e.g. via LTE/satellite/LAN/WLAN). The system 100 may optionally be provided with one or more of the following equipment: Automatic Dependent Surveillance-Broadcast (ADS-B) systems for displaying nearby aircraft traffic on a map, Global Navigation Satellite System (GNSS) base stations for surveying data, security cameras, floodlights for artificial illumination in low-light conditions, weather stations and lightning detectors, and airband radio for local radio communication and aircraft.

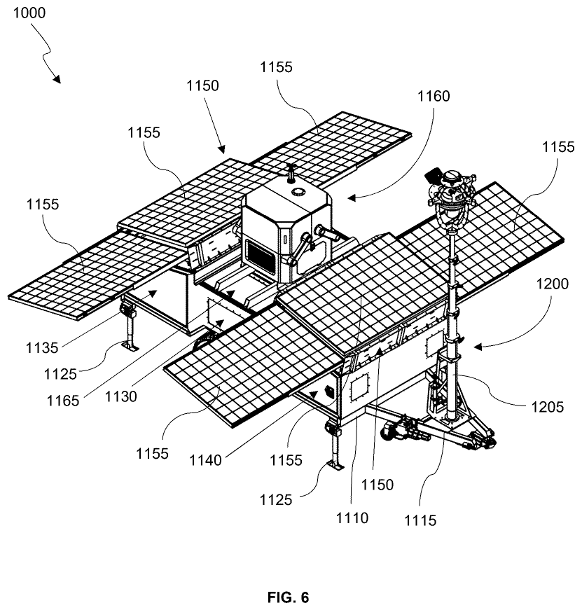

In FIG. 6 of the accompanying drawings, there is schematically depicted another embodiment of a drone system 1000 that is adaptable for use with multiple technological applications. The drone system 1000 operates in a similar manner to the drone system 100 described above, with like reference numeral being used to describe like features. It will be appreciated that any one or more of the components of the drone system 100 described above may be interchanged with the components of the drone system 1000, depending on the design and use requirements. It will further be appreciated that the number and location of the various components of the drone systems 100 and 1000 are not necessarily limited to the arrangement as shown in the drawings and described herein, and may be adjusted or removed depending on the design and use requirements thereof.

In the depicted embodiment, the drone system 1000 is shown with the solar panel assemblies 1150 in their expanded configurations, whereby two of the solar panels 1155 are extended outwardly in a wing-style arrangement. The watchtower assembly 1200 is also shown in an extended arrangement in this embodiment. As with the embodiment of the drone system 100 described above, the watchtower assembly 1200 of this embodiment is mounted to the draw bar 1115 of the trailer by way of a bracket assembly 1210, which functions in a similar manner to the bracket assembly 210 described above.

Various forms of the systems described above may have one or more of the following advantages.

It will be appreciated that the arrangement of the system and the design of the trailer may at least allow for low installation requirements, eliminating the need for footing (concrete pad), electrical, or networking infrastructure.

The system may be easily relocated without the need to decommission old infrastructure or install new infrastructure if site requirements change, resulting in a net-zero long-term footprint. Further, the arrangements described above may allow for the integration of multiple functions from existing but independent products into one system, thereby simplifying the usage and management of these services (which, as described above, may include CCTV solutions, ADS-B services, airspace maps, drone ground control software, GNSS service, and local weather monitoring). Accordingly, the system may be independent in terms of power, connectivity, and operations.

The arrangements described above may also provide automation opportunities to expedite existing workflows, including data collection, validation, processing, delivery, and storage.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

List of reference numerals:

| | |
|---|---|
| 100 | Drone system |
| 105 | Trailer |
| 110 | Chassis |
| 115 | Draw bar |
| 120 | Wheel(s) |
| 125 | Support member(s) |
| 130 | Central compartment |
| 135 | First compartment or cabin |
| 140 | Second compartment or cabin |
| 142 | Upper surface of first |
| | compartment |
| 144 | Upper surface of second |
| | compartment |
| 146 | Door of first compartment |
| 148 | Door of second compartment |
| 150 | Solar panel assembly |
| 155 | Solar panel(s) |
| 160 | Drone assembly |
| 165 | Payload area |
| 170 | Mounting assembly |
| 175 | Further mounting assembly |
| 200 | Watchtower (mast) assembly |
| 205 | Mast |
| 210 | Bracket or mounting assembly |
| 300 | Modular frame structure for |
| | three batteries |
| 400 | Modular frame structure for two |
| | by three batteries |
| 1000 | Drone system |
| 1105 | Trailer |
| 1110 | Chassis |
| 1115 | Draw bar |
| 1120 | Wheel(s) |
| 1125 | Support member(s) |
| 1130 | Central compartment |
| 1135 | First compartment or cabin |
| 1140 | Second compartment or cabin |
| 1142 | Upper surface of first |
| | compartment |
| 1144 | Upper surface of second |
| | compartment |
| 1146 | Door of first compartment |
| 1148 | Door of second compartment |
| 1150 | Solar panel assembly |
| 1155 | Solar panel(s) |
| 1160 | Drone assembly |
| 1165 | Payload area |
| 1170 | Mounting assembly |
| 1175 | Further mounting assembly |
| 1200 | Watchtower (mast) assembly |
| 1205 | Mast |
| 1210 | Bracket or mounting assembly |
| 1300 | Modular frame structure for |
| | three batteries |
| 1400 | Modular frame structure for two |
| | by three batteries |

1. A drone system including:
a trailer including a chassis and a draw bar extending from the chassis, the chassis being supported on a surface by one or more wheels and one or more support members;
a plurality of cabins mounted to the chassis, with each cabin having an upper surface;
at least one solar panel assembly mounted to an upper surface of one of the cabins; and
a drone landing dock provided on an upper surface of another one of the cabins.

2. The drone system according to claim 1, further including an air conditioning system housed in one of the cabins, wherein the air conditioning system is operable to manage the cooling and/or pressure of the cabins.

3. The drone system according to claim 1 or 2, wherein the one or more support members are height-adjustable to allow for levelling of the drone system on uneven terrain.

4. The drone system according to claim 1, wherein the plurality of cabins includes:
a central cabin flanked by a first cabin and a second cabin,
wherein the drone landing dock is provided on an upper surface of the central cabin, and wherein the at least one solar panel assembly is provided on an upper surface of the first or second cabin.

5. The drone system according to claim 4, wherein the drone system includes two of the solar panel assemblies, with the first of the two solar panel assemblies being mounted on an upper surface of the first cabin, and the second of the two solar panel assemblies being mounted on an upper surface of the second cabin.

6. The drone system according to claim 5, wherein each solar panel assembly includes a plurality of solar panels and is moveable between a retracted configuration whereby the solar panels are in a stowed arrangement and an expanded configuration whereby the solar panels are in an outwardly extended arrangement.

7. The drone system according to claim 6, wherein each solar panel assembly includes three solar panels, whereby in the retracted configuration, the three solar panels are stacked in relation to each other, and in the expanded configuration, two of the solar panels extend outwardly from the third, central solar panel.

8. The drone system according to claim 1, wherein each solar panel assembly is operatively associated with a charger, with the charger being located in any one of the cabins.

9. The drone system according to claim 1, wherein each solar panel assembly is operatively associated with a solar panel isolator located in one of the cabins.

10. The drone system according to claim 1, further including a plurality of batteries located in any one or more of the cabins, wherein power from the solar panel assembly is stored across the plurality of batteries.

11. The drone system according to claim 10, wherein the batteries are operatively associated with a battery isolator located in one or more of the cabins.

12. The drone system according to claim 10 or 11, wherein the batteries are housed in one or more modular frame structures located in one of the cabins.

13. The drone system according to claim 12, wherein the modular frame structures are repositionable to allow for weight distribution of the batteries across the trailer.

14. The drone system according to claim 1, wherein the central cabin, first cabin, and second cabin are integrally formed to have a common internal cavity.

15. The drone system according to claim 14, wherein the cabins each include a door providing access to the internal cavity, wherein the door includes waterproof seals having an IP67 Rating.

16. The drone system according to claim 1, wherein the central cabin, first cabin, and second cabin are separately formed.

17. The drone system according to claim 1, wherein the cabins include at least one port for mains supply, a generator, or any alternative power source.

18. The drone system according to claim 1, further including a drone assembly operatively associated with the mounting assembly.

19. The drone system according to claim 1, further including a watchtower assembly having:
a mast disposed over the draw bar of the trailer, with the mast being moveable between a retracted configuration and an extended configuration; and
a bracket assembly adapted for mounting the mast to the draw bar; and one or more IoT devices mounted to the mast and configured to provide real-time operational data associated with the system, with the one or more IoT devices being operatively associated with power and data components located within the cabins.
